(19) United States
(12) Patent Application Publication
(10) Pub. No.: US 2011/0033209 A1
(43) Pub. Date: Feb. 10, 2011

(54) FEED ROLLER HAVING TAKE-OFF MAGNETS

(76) Inventor: Eric C. Stelter, Pittsford, NY (US)

Correspondence Address: Andrew J. Anderson, Patent Legal Staff,;Eastman Kodak Company, 343 State Street, Rochester, NY, 14650-2201, US

(21) Appl. No.: 12/535,839

(22) Filed: Aug. 5, 2009

(51) Int. Cl. G03G 15/09

(52) U.S. Cl. 399/272

(57) ABSTRACT

An electrophotographic imaging system has a dielectric support member (DSM), a primary charging station configured to form a charge layer on the DSM, and an exposure station configured to selectively discharge the charge layer formed on the DSM, thereby producing a latent image on the DSM. The electrophotographic imaging system also has a development station configured to develop the latent image on the DSM with toner. The development station has a rotating shell, a rotating magnetic core within the rotating shell, and a sump. The development station also has a feeding apparatus configured to supply fresh developer from the sump to the rotating shell. The feeding apparatus has a feed roller, one or more feed magnets within the feed roller, and one or more take-off magnets within the feed roller. The feed roller is rotatable around the one or more feed magnets and the one or more take-off magnets.

### FIELD OF THE INVENTION

The claimed invention relates in general to electrophotographic imaging systems, and more particularly to an electrophotographic development apparatus having a feed roller with one or more take-off magnets.

### BACKGROUND OF THE INVENTION

In a typical commercial reproduction apparatus (electrographic copier/duplicators, printers, or the like), a latent image charge pattern is formed on a uniformly charged charge-retentive or photoconductive member having dielectric characteristics (hereinafter referred to as the dielectric support member). Pigmented marking particles (for example, toner) are manipulated into close proximity with the latent image charge pattern by a one or more development stations, allowing the pigmented marking particles to be attracted to the latent image charge pattern in order to develop such image on the dielectric support member. A receiver member, such as a sheet of paper, transparency or other medium, is then brought directly, or indirectly via an intermediate transfer member, into contact with the dielectric support member, and an electric field is applied to transfer the marking particle developed image to the receiver member from the dielectric support member. After transfer, the receiver member bearing the transferred image is transported away from the dielectric support member, and the image is fixed (fused) to the receiver member by heat and/or pressure to form a permanent reproduction thereon.

The development system of an electrophotographic reproduction apparatus is ideally designed to provide a uniform toner concentration to the passing dielectric support member so that a uniformly charged latent image on the dielectric support member will be developed with a proportionally uniform density of toner. Unfortunately, many existing electrophotographic development stations have undesirable toner concentration uniformity due to the influence of depleted developer of a first toner concentration mixing with fresh developer of a second toner concentration on a toning roller. The resultant toner non-uniformity can produce objectionable “depletion streaks” on output images.

Therefore, it would be beneficial if there were an inexpensive, yet reliable, apparatus for reducing depletion streaks that could easily be implemented.

### SUMMARY OF THE INVENTION

In view of the above, the claimed invention is directed towards a feeding apparatus. The feeding apparatus has a feed roller, one or more feed magnets within the feed roller, and one or more take-off magnets within the feed roller. The feed roller is rotatable around the one or more feed magnets and the one or more take-off magnets.

The claimed invention is also directed towards a development station. The development station has a rotating shell, a rotating magnetic core within the rotating shell, and a sump region. The development station also has a feeding apparatus configured to supply fresh developer from the sump region to the rotating shell. The feeding apparatus has a feed roller, one or more feed magnets within the feed roller, and one or more take-off magnets within the feed roller. The feed roller is rotatable around the one or more feed magnets and the one or more take-off magnets.

The claimed invention is also directed towards an electrophotographic imaging system. The electrophotographic imaging system has a dielectric support member (DSM), a primary charging station configured to form a charge layer on the DSM, and an exposure station configured to selectively discharge the charge layer formed on the DSM, thereby producing a latent image on the DSM. The electrophotographic imaging system also has a development station configured to develop the latent image on the DSM with toner. The development station has a rotating shell, a rotating magnetic core within the rotating shell, and a sump region. The development station also has a feeding apparatus configured to supply fresh developer from the sump region to the rotating shell. The feeding apparatus has a feed roller, one or more feed magnets within the feed roller, and one or more take-off magnets within the feed roller. The feed roller is rotatable around the one or more feed magnets and the one or more take-off magnets.

The invention, and its objects and advantages, will become more apparent in the detailed description of the preferred embodiment presented below.

### BRIEF DESCRIPTION OF THE DRAWINGS

FIG. 1A schematically illustrates an embodiment of an electrophotographic print engine.

FIG. 1B schematically illustrates an alternate embodiment of a print engine.

FIG. 2 schematically illustrates an embodiment of a development station having a rotating shell and a rotating magnetic core.

FIG. 3 schematically illustrates an embodiment of a feeding apparatus 93 for an electrostatic development station.

FIG. 4 schematically illustrates the development station from FIG. 2 with an embodiment of the feeding apparatus from FIG. 3.

FIG. 5 schematically illustrates an embodiment of feed magnets and take-off magnets.

FIGS. 6A-6E schematically illustrate the operation of an embodiment of a feed roller having take-off magnets in a development station as part of an electrophotographic imaging system.

FIG. 7 schematically illustrates another embodiment of a development station.

FIG. 8 schematically illustrates an embodiment of a nip defined between a feed roller and a rotating shell of an electrostatic development station.

It will be appreciated that for purposes of clarity and where deemed appropriate, reference numerals have been repeated in the figures to indicate corresponding features, and that the various elements in the drawings have not necessarily been drawn to scale in order to better show the features.

### DETAILED DESCRIPTION OF THE INVENTION

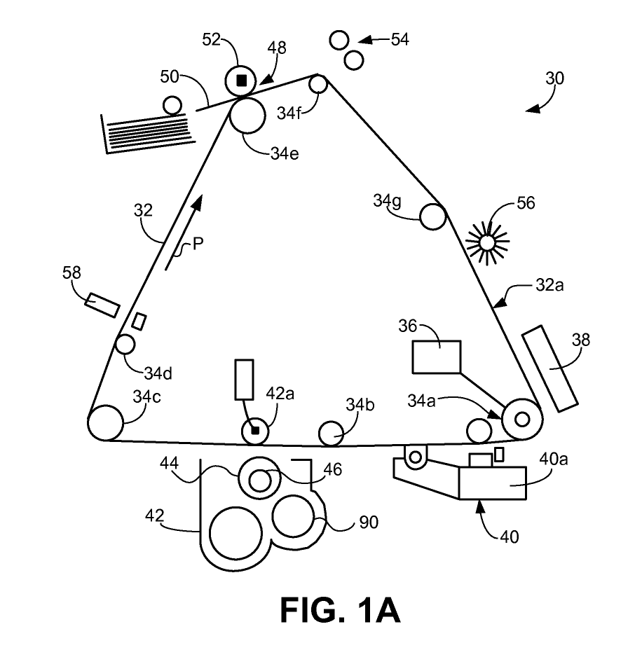

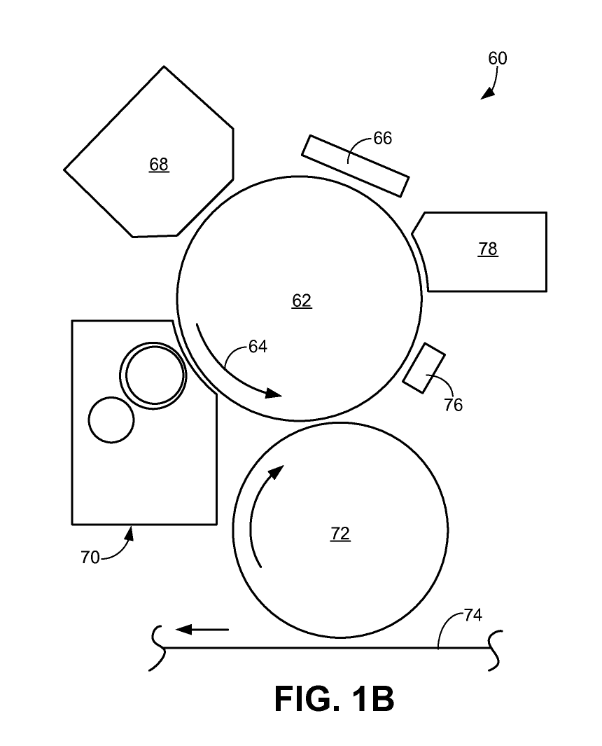

FIG. 1A schematically illustrates an embodiment of an electrophotographic print engine 30. The print engine 30 has a movable recording member such as a photoconductive belt 32 which is entrained about a plurality of rollers or other supports 34a through 34g. The photoconductive belt 32 may be more generally referred-to as a dielectric support member (DSM) 32. A dielectric support member (DSM) 32 may be any charge carrying substrate which may be selectively charged or discharged by a variety of methods including, but not limited to corona charging/discharging, gated corona charging/discharging, charge roller charging/discharging, ion writer charging, light discharging, heat discharging, and time discharging.

One or more of the rollers 34a-34g are driven by a motor 36 to advance the DSM 32. Motor 36 preferably advances the DSM 32 at a high speed, such as 20 inches per second or higher, in the direction indicated by arrow P, past a series of workstations of the print engine 30, although other operating speeds may be used, depending on the embodiment. In some embodiments, DSM 32 may be wrapped and secured about only a single drum. In further embodiments, DSM 32 may be coated onto or integral with a drum.

Print engine 30 may include a controller or logic and control unit (LCU) (not shown). The LCU may be a computer, microprocessor, application specific integrated circuit (ASIC), digital circuitry, analog circuitry, or an combination or plurality thereof. The controller (LCU) may be operated according to a stored program for actuating the workstations within print engine 30, effecting overall control of print engine 30 and its various subsystems. The LCU may also be programmed to provide closed-loop control of the print engine 30 in response to signals from various sensors and encoders. Aspects of process control are described in U.S. Pat. No. 6,121,986 incorporated herein by this reference.

A primary charging station 38 in print engine 30 sensitizes DSM 32 by applying a uniform electrostatic corona charge, from high-voltage charging wires at a predetermined primary voltage, to a surface 32a of DSM 32. The output of charging station 38 may be regulated by a programmable voltage controller (not shown), which may in turn be controlled by the LCU to adjust this primary voltage, for example by controlling the electrical potential of a grid and thus controlling movement of the corona charge. Other forms of chargers, including brush or roller chargers, may also be used.

An image writer, such as exposure station 40 in print engine 30 projects light from a writer 40a to DSM 32. This light selectively dissipates the electrostatic charge on photoconductive DSM 32 to form a latent electrostatic image of the document to be copied or printed. Writer 40a is preferably constructed as an array of light emitting diodes (LEDs), or alternatively as another light source such as a Laser or spatial light modulator. Writer 40a exposes individual picture elements (pixels) of DSM 32 with light at a regulated intensity and exposure, in the manner described below. The exposing light discharges selected pixel locations of the photoconductor, so that the pattern of localized voltages across the photoconductor corresponds to the image to be printed. An image is a pattern of physical light which may include characters, words, text, and other features such as graphics, photos, etc. An image may be included in a set of one or more images, such as in images of the pages of a document. An image may be divided into segments, objects, or structures each of which is itself an image. A segment, object or structure of an image may be of any size up to and including the whole image.

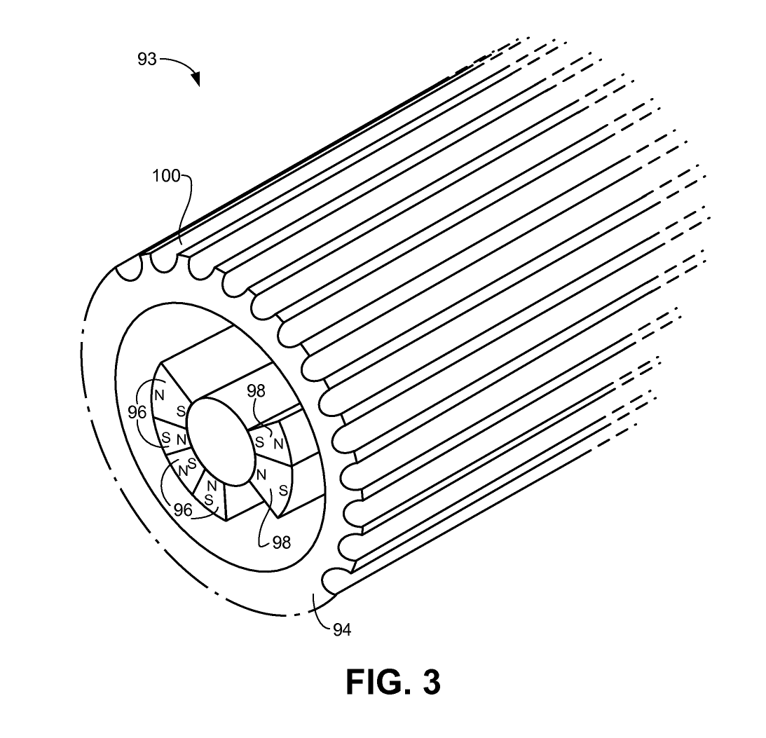

After exposure, the portion of DSM 32 bearing the latent charge images travels to a development station 42. Development station 42 includes a rotating shell 44 in juxtaposition to the DSM 32. The rotating shell 44 surrounds a rotating magnetic core 46 that helps magnetic toner (not shown in this view) adhere to the rotating shell 44. Development station 42 is shown with a feeding apparatus including a feed roller 90 which is discussed in one embodiment, in conjunction with FIG. 3 below. Plural development stations 42 may be provided for developing images in plural grey scales, colors, or from toners of different physical characteristics. Full process color electrographic printing is accomplished by utilizing this process for each of four toner colors (e.g., black, cyan, magenta, and yellow).

Upon the imaged portion of DSM 32 reaching development station 42, the LCU selectively activates development station 42 to apply toner to DSM 32 by moving backup roller 42a and DSM 32, into engagement with or close proximity to the rotating shell 44. Alternatively, the development station 42 and/or the rotating shell 44 may be moved toward DSM 32 to selectively engage DSM 32. In still other embodiments, neither the development station 42, the rotating shell 44, the DSM 32, nor the backup roller 42a are moved. Instead, the development station may be activated by switching electrical biases on/off. In any of the above cases, charged toner particles on the rotating shell 44 are selectively attracted to the latent image patterns present on DSM 32, developing those image patterns. As the exposed photoconductor passes the developing station, toner is attracted to pixel locations of the photoconductor and as a result, a pattern of toner corresponding to the image to be printed appears on the photoconductor. As known in the art, conductor portions of development station 42, such as conductive applicator cylinders, are biased to act as electrodes. The electrodes are connected to a variable supply voltage, which is regulated by a programmable controller in response to the LCU, by way of which the development process is controlled.

Development station 42 may contain a two component developer mix which comprises a dry mixture of toner and carrier particles. Typically the carrier preferably comprises high coercivity (hard magnetic) ferrite particles. As a non-limiting example, the carrier particles may have a volume-weighted diameter of approximately 30μ. The dry toner particles are substantially smaller, on the order of 6μ to 15μ in volume-weighted diameter. The rotating magnetic core 46 and the rotating shell 44 may be rotatably driven by a motor or other suitable driving means. Relative rotation of the core 46 and shell 44 moves the developer through a development zone in the presence of an electrical field. In the course of development, the toner selectively electrostatically adheres to DSM 32 to develop the electrostatic images thereon and the carrier material remains at development station 42. As toner is depleted from the development station due to the development of the electrostatic image, additional toner may be periodically introduced by a toner auger into development station 42 to be mixed with the carrier particles to maintain a uniform amount of development mixture. This development mixture is controlled in accordance with various development control processes.

A transfer station 48 in printing engine 30 moves a receiver sheet 50 into engagement with the DSM 32, in registration with a developed image to transfer the developed image to receiver sheet 50. Receiver sheets 50 may be plain or coated paper, plastic, or another medium capable of being handled by the print engine 30. Typically, transfer station 48 includes a charging device for electrostatically biasing movement of the toner particles from DSM 32 to receiver sheet 50. In this example, the biasing device is roller 52, which engages the back of sheet 50 and which may be connected to a programmable voltage controller that operates in a constant current mode during transfer. Alternatively, an intermediate member may have the image transferred to it and the image may then be transferred to receiver sheet 50. After transfer of the toner image to receiver sheet 50, sheet 50 is detached from DSM 32 and transported to fuser station 54 where the image is fixed onto sheet 50, typically by the application of heat and/or pressure. Alternatively, the image may be fixed to sheet 50 at the time of transfer.

A cleaning station 56, such as a brush, blade, or web is also located beyond transfer station 48, and removes residual toner from DSM 32. A pre-clean charger (not shown) may be located before or at cleaning station 56 to assist in this cleaning. After cleaning, this portion 32a of DSM 32 is then ready for recharging and re-exposure. Of course, other portions of DSM 32 are simultaneously located at the various workstations of print engine 30, so that the printing process may be carried out in a substantially continuous manner.

A controller provides overall control of the apparatus and its various subsystems with the assistance of one or more sensors which may be used to gather control process input data. One example of a sensor is belt position sensor 58.

FIG. 1B schematically illustrates an alternate embodiment of a print engine 60. The print engine 60 has a photoconductive drum 62 for a dielectric support member (DSM). Toner images are formed on the photoconductive surface of DSM 62 by rotating the drum in a counter-clockwise direction 64 past a series of image processing stations that sequentially operate on a desired portion of the drum's photoconductive outer surface to produce a visible toner image. These image processing stations may include a primary charging station 66 for uniformly charging the DSM 62 surface with electrostatic charges, an exposure station 68 for imagewise exposing the charged DSM 62 surface, leaving behind a latent electrostatic charge image, and a development station 70 for developing the charge image with pigmented electroscopic toner particles.

In this embodiment, the print engine 60 also has an intermediate image-transfer drum 72 to which toner images formed on the DSM 62 are transferred prior to being re-transferred to a receiver sheet 74. Following transfer to the intermediate transfer drum 72, residual toner on the DSM 62 may be removed by the combination of an optional pre-clean corona charger 76 and a cleaning station 78.

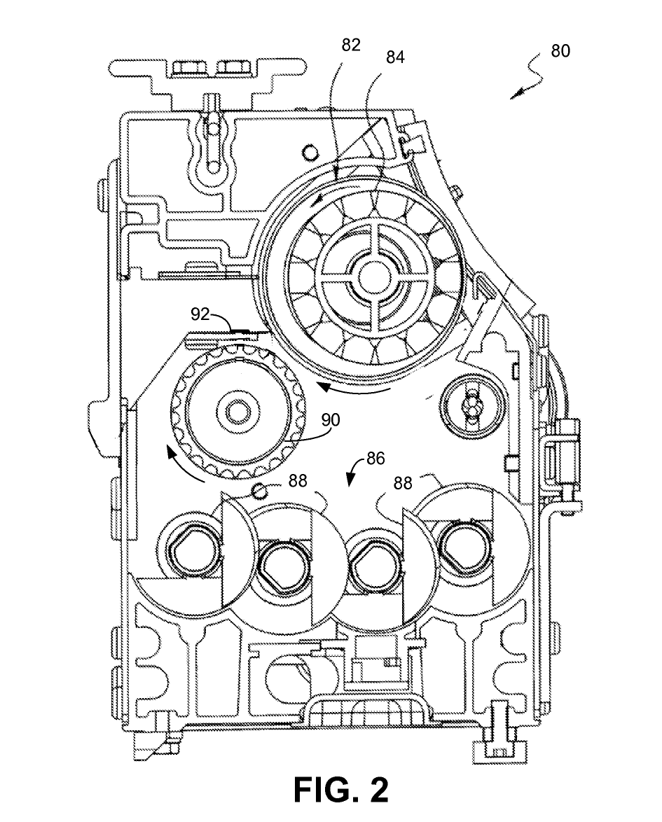

FIG. 2 schematically illustrates an embodiment of a development station 80 having a rotating shell 82 and a rotating magnetic core 84. In this embodiment, the development station 80 has a sump region 86 where developer (magnetic carrier plus toner) remains available for use in development. The development station 80 may have one or more mixing devices 88, such as an auger or one or more paddles which rotate in contact with the developer in the sump region 86, stirring the developer, and causing the toner particles in the developer to accumulate a triboelectric charge from the mixing motion.

A feed roller 90, as part of a feeding apparatus, may house one or more feed magnets to pull developer from the sump region 60 and deliver it to the rotating shell 82. The developer adheres to the rotating shell 82 due to the magnetic fields created by the rotating magnetic core 84 located within the rotating shell 82. A metering blade 92 may be provided in proximity to the rotating shell 82 to assist in controlling the height of developer on the rotating shell 82.

FIG. 3 schematically illustrates an embodiment of a feeding apparatus 93 for an electrostatic development station. The feeding apparatus 93 has a feed roller 94 with one or more feed magnets 96 and one or more take-off magnets 98 extending through the core of the feed roller 94 and substantially parallel to the longitudinal axis of the feed roller 94. Both the feed magnets 96 and the take-off magnets 98 are substantially fixed during operation. The feed roller 94 is free to rotate about the magnets 96, 98. In this embodiment, the feed roller 94 defines a plurality of grooves, such as groove 100 which runs parallel to a longitudinal axis of the feed roller 94. Although the grooves 100 are illustrated in this embodiment as being arcuate in cross-section, other embodiments may have different shaped grooves. Furthermore, although it is preferred to have some form of grooves 100 in the feed roller 94, other embodiments of feed rollers may not have grooves.

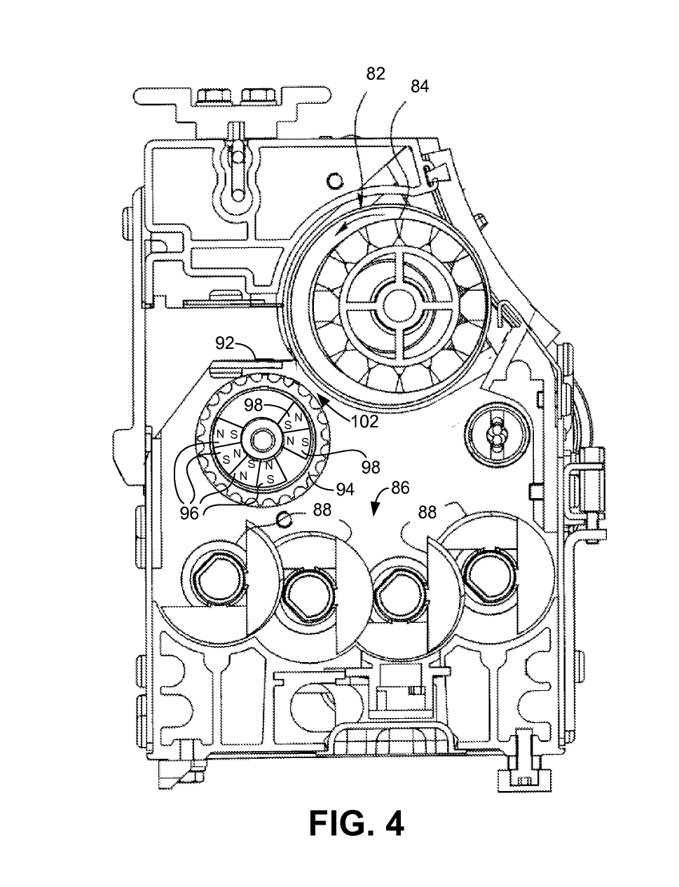

FIG. 4 schematically illustrates the development station from FIG. 2 with an embodiment of the feeding apparatus 93 from FIG. 3. The feed magnets 96 are positioned near the sump region 86 in order to facilitate attraction of developer to the feed roller 90. The take-off magnets 98 are adjacent to the rotating shell 82 and remove developer from the rotating shell 82 as a surface of the rotating shell 82 moves into a nip 102 between the rotating shell 82 and the feed roller 94. The take-off magnets 98 are preferably constructed of a high-coercivity material so that the magnetic field created by the take-off magnets 98 is not significantly reduced by the magnetic core 84 inside the rotating shell 82.

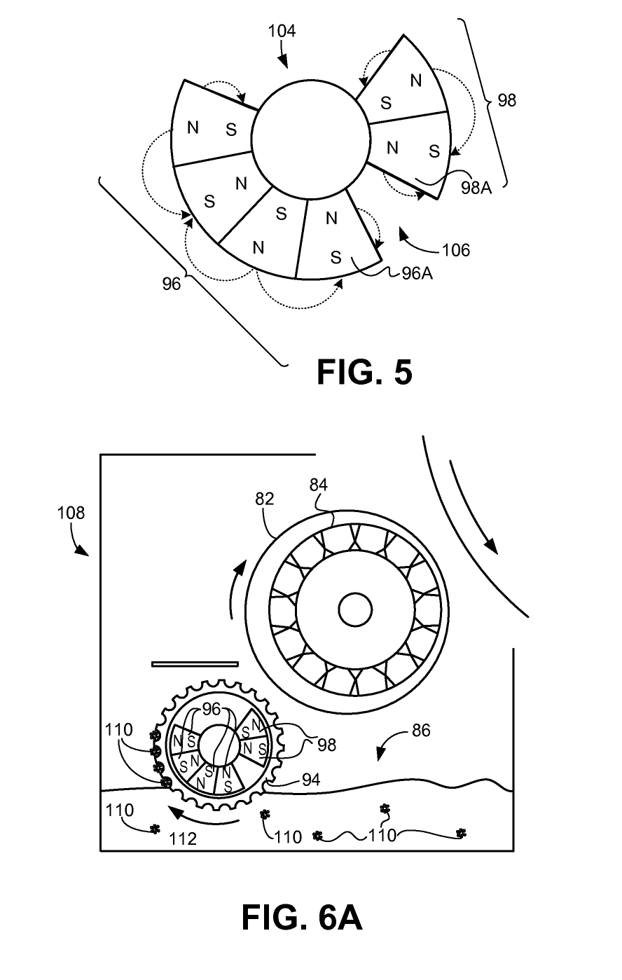

An embodiment of the feed magnets 96 and the take-off magnets 98 are schematically illustrated on their own in FIG. 5. The one or more feed magnets in FIG. 5 include a plurality of feed magnets and each of the plurality of feed magnets are arranged in alternating magnetic polarity. The one or more take-off magnets in FIG. 5 include a plurality of take-off magnets and each of the plurality of take-off magnets are arranged in alternating polarity.

The feed magnets 96 and the take-off magnets 98 are illustrated as defining, or being separated by, two gaps: a post-feed gap 104, and a post-take-off gap 106. The magnetic field lines are schematically sketched in FIG. 5 as dotted lines. At the post-take-off gap 106, the adjacent pole for the feed magnet 96A and the adjacent pole for the take-off magnet 98A preferably have the same polarity to prevent bridging of the post-take-off gap 106 by the magnetic developer. This effectively creates an area adjacent to the post-take-off gap 106 which has no magnetic field, thereby enabling depleted developer taken from the rotating shell to fall off of the feed roller and into the sump.

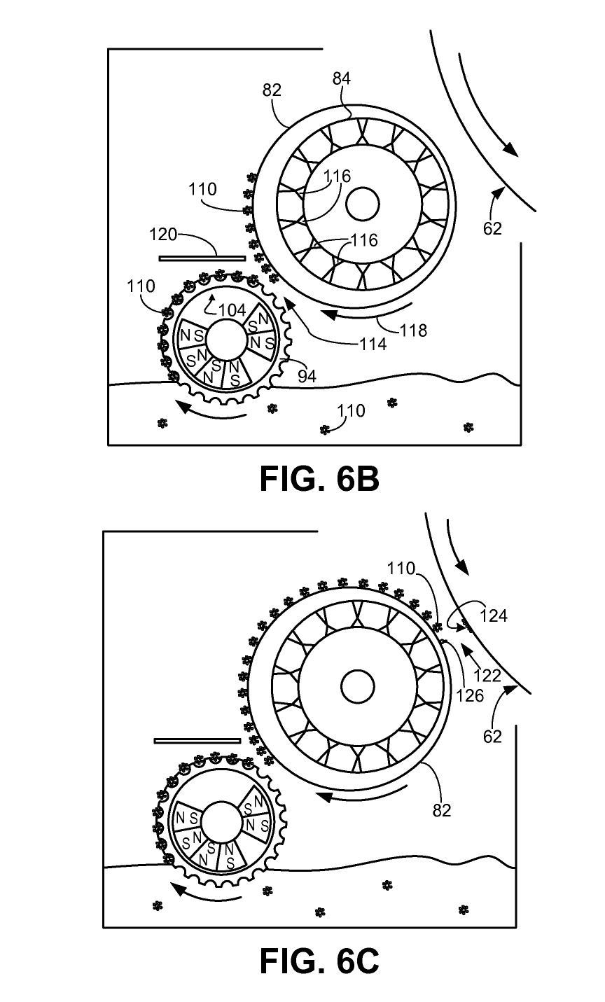

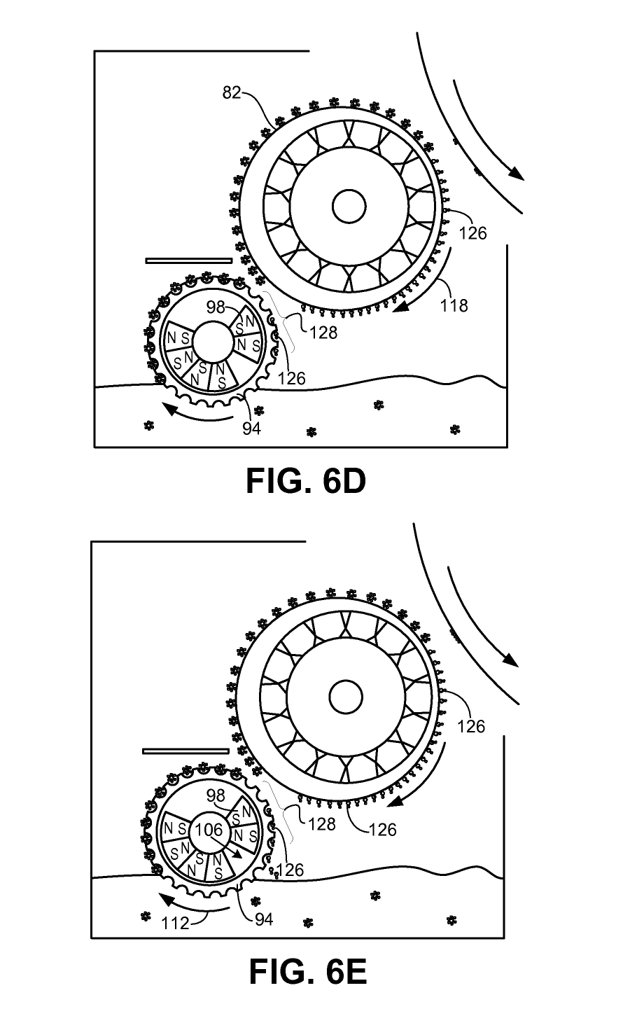

FIGS. 6A-6E schematically illustrate the operation of an embodiment of a feed roller 94 having take-off magnets 98 in a development station 108 as part of an electrophotographic imaging system. Exemplary elements of an electrophotographic imaging system beyond the development station 108 have been discussed above and are therefore not illustrated in this view. For simplicity, the sump region 86 is illustrated as being filled with fresh developer 110 as a result of the developer station mixing devices which are not shown in this view, but are well-known to those skilled in the art. Developer is a mixture of a magnetic carrier and a toner. Fresh developer 110 has a higher concentration of toner on the carrier particles as compared to carrier which has been stripped of toner particles during the development process. As FIG. 6A illustrates in this embodiment, the feed roller 94 rotates in a clockwise direction 112 and fresh developer 110 is attracted to the feed roller 94 in the vicinity of the feed magnets 96. The fresh developer 110 is carried clockwise out of the sump 86 and towards the rotating shell 82.

As FIG. 6B illustrates, the fresh developer 110 is carried clockwise on the feed roller 94 over the post-feed-gap 104 and towards the nip 114 between the feed roller 94 and the rotating shell 82. The magnets 116 of the rotating magnetic core 84 attract the fresh developer 110 to the rotating shell 82, and the fresh developer 110 on the rotating shell 82 moves clockwise 118 towards the dielectric support member (DSM) 62. For ease of illustration and explanation, a single layer of developer is illustrated in these views. It should be understood, however, that actual developer held to the feed roller 94 and the rotating shell 82 may be multiple layers thick. Therefore, a metering skive 120 may be used to ensure that a relatively uniform layer of fresh developer 110 is coating the rotating shell 82.

As FIG. 6C illustrates, the fresh developer 110 is carried clockwise towards the nip 122 between the rotating shell 82 and the DSM 62. As described earlier, the imaging system can form an electrostatic latent image on the surface of the DSM 62. An electric bias between the rotating shell 82 and the DSM 62 is set so that toner 124 from the fresh developer 110 will leave the carrier and jump to the DSM 62 by being attracted to either the charged latent image areas or the discharged latent image areas, depending on whether a charged area development system or a discharged area development system is being used. As a result of this development, the developer may be stripped of some or all of its toner, and may now be referred-to as depleted developer 126.

As FIG. 6D illustrates, the depleted developer 126 is carried clockwise 118 towards the feed roller 94 near the area 128 where the magnetic field from the take-off-magnets 98 can affect the depleted developer 126. The depleted developer 126 is substantially removed from the rotating shell 82 and attracted to the feed roller 94 in the take-off-magnet magnetic field area 128. The rotating shell 82, now substantially cleared of depleted developer, is able to pick-up a higher concentration of fresh toner 110 than if the depleted developer were still present on the shell 82. Fresh developer 110 has a higher toner concentration and is more uniformly mixed than depleted developer, thereby enabling more uniform images to be produced.

As FIG. 6E illustrates, as the feed roller 94 continues to rotate clockwise 112, the depleted developer 126 on the feed roller 94 will eventually pass beyond the take-off-magnet magnetic field area 128, and can fall off of the feed roller 94 back into the sump 86 in order to be refreshed with additional toner from the sump 86. The lack of magnetic field in the post-take-off gap 106 also assists with allowing the depleted developer 126 to fall off of the feed roller 94.

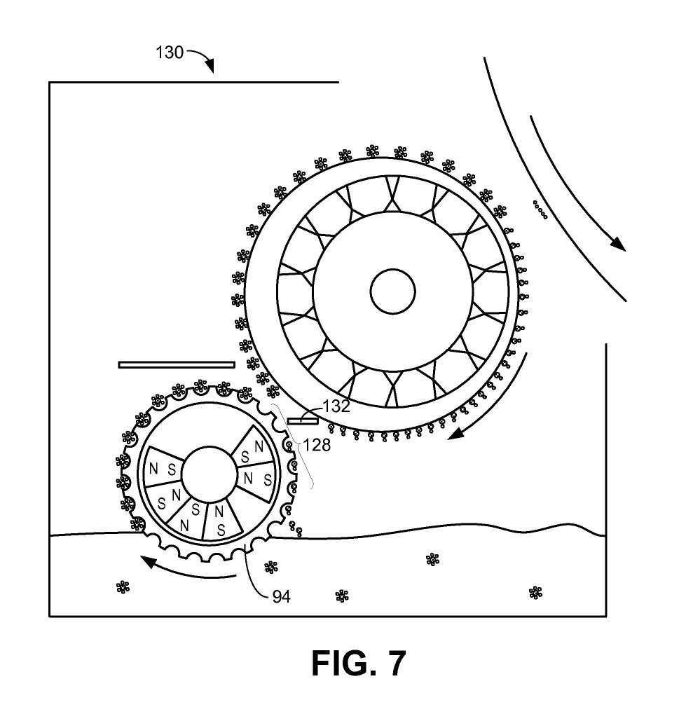

FIG. 7 schematically illustrates another embodiment of a development station 130. The development station 130 is similar to the development station of FIGS. 6A-6E with the addition of an optional take-off skive 132. The take-off skive 132 helps to remove developer from the rotating shell 82 so that the depleted developer may more easily be attracted to the feed roller 94 in the take-off magnet magnetic field area 128.

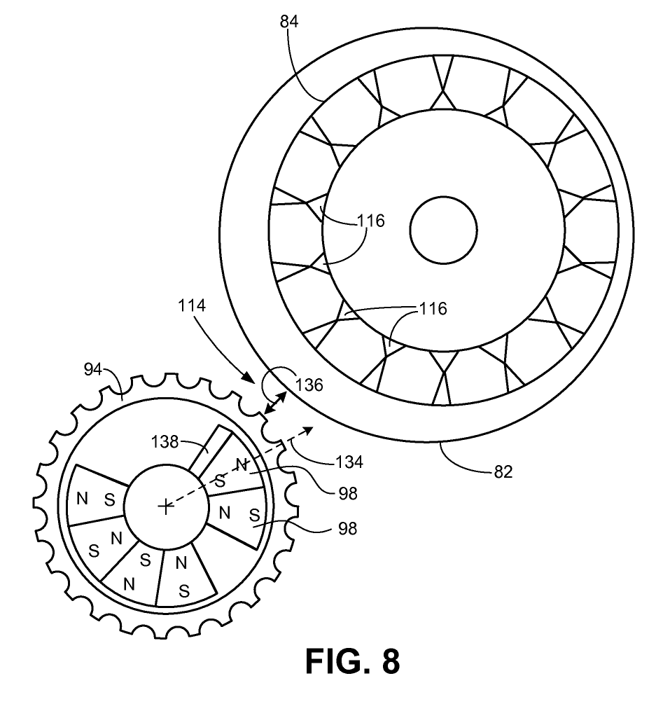

FIG. 8 schematically illustrates an embodiment of the nip 114 defined between the feed roller 94 and the rotating shell 82. Since the magnets 116 of the rotating magnetic core 84 tend to attract developer from the feed roller 94 to the rotating shell 82, and since the take-off magnets 98 tend to attract developer from the rotating shell 82 to the feed roller 94, it is preferable to align the axis 134 of the take-off magnet 98 nearest the rotating shell 82 such that the axis is not aligned with the minimum gap 136 between the feed roller 94 and the rotating shell 82. In this manner, the one or more take-off magnets 98 will be less likely to interfere with the transfer of fresh developer from the feed roller 94 to the rotating shell 82. Additionally, an optional magnetic shunt 138 may be placed adjacent to the one or more take-off magnets 98 to further reduce the effect of the take-off magnets 98 on the fresh developer.

The advantages of an electrostatic development station having a feed roller with one or more take-off magnets have been discussed herein. Embodiments discussed have been described by way of example in this specification. It will be apparent to those skilled in the art that the foregoing detailed disclosure is intended to be presented by way of example only, and is not limiting. Various other alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of processing elements or sequences, or the use of numbers, letters, or other designations therefore, is not intended to limit the claims to any order, except as may be specified in the claims. Accordingly, the invention is limited only by the following claims and equivalents thereto.

### Parts List

30 print engine
32 dielectric support member (DSM)
34a driven roller
34b roller
34c roller
34d roller
34e roller
34f roller
34g roller
36 motor
38 primary charging station
40 exposure station (image writer)
40a writer
42 development station
42a backup roller
44 rotating shell
46 rotating magnetic core
48 transfer station
50 receiver sheet
52 biasing roller
54 fuser station
56 cleaning station
58 belt position sensor
60 print engine
62 photoconductive drum
64 counter-clockwise direction
66 primary charging station
68 exposure station
70 development station
72 intermediate transfer drum
74 receiver sheet
76 pre-clean corona charger
78 cleaning station
80 development station
82 rotating shell
84 rotating magnetic core
86 sump region
88 mixing devices
90 feed roller
92 metering blade
93 feeding apparatus
94 feed roller
96 feed magnets
98 take-off magnets
100 feed roller groove
102 nip between feed roller and rotating shell
104 post-feed gap
106 post-take-off gap
108 development station
110 fresh developer
112 clockwise direction
114 nip between feed roller and rotating shell
116 core magnets
118 clockwise direction
120 metering skive
122 nip between rotating shell and dielectric support member
124 toner
126 depleted developer
128 take-off magnet magnetic field area
130 development station
132 take-off skive
134 axis of the take-off magnet nearest the rotating shell
136 minimum gap between the feed roller and the rotating shell
138 magnetic shunt

What is claimed is:

1. A feeding apparatus, comprising:
a feed roller;
one or more feed magnets within the feed roller;
one or more take-off magnets within the feed roller; and
wherein the feed roller is rotatable around the one or more feed magnets and the one or more take-off magnets.

2. The feeding apparatus of claim 1, wherein the one or more feed magnets comprise a plurality of feed magnets and each of the plurality of feed magnets are arranged in alternating magnetic polarity.

3. The feeding apparatus of claim 1, wherein the one or more take-off magnets comprise a plurality of take-off magnets and each of the plurality of take-off magnets are arranged in alternating polarity.

4. The feeding apparatus of claim 1, wherein the one or more feed magnets and the one or more take-off magnets define a post-take-off gap.

5. The feeding apparatus of claim 4, wherein:
a first feed magnet of the one or more feed magnets is adjacent the post-take-off gap;
a first take-off magnet of the one or more take-off magnets is adjacent the post-take-off gap; and
the first feed magnet and the first take-off magnet have the same polarity.

6. The feeding apparatus of claim 1, wherein the one or more feed magnets and the one or more take-off magnets define a post-feed gap; and
the feeding apparatus further comprises a magnetic shunt in the post-feed gap.

7. The feeding apparatus of claim 1, wherein the feed roller further comprises a plurality of grooves.

8. The feeding apparatus of claim 1, wherein the one or more feed magnets and the one or more take-off magnets define a post-feed gap; and
a first feed magnet of the one or more feed magnets is adjacent the post-feed gap;
a first take-off magnet of the one or more take-off magnets is adjacent the post-feed gap; and
the first feed magnet and the first take-off magnet have the same polarity.

9. A development station, comprising:
a) a rotating shell;
b) a rotating magnetic core within the rotating shell;
c) a sump region; and
d) a feeding apparatus configured to supply fresh developer from the sump region to the rotating shell, wherein the feeding apparatus comprises:
1) a feed roller;
2) one or more feed magnets within the feed roller;
3) one or more take-off magnets within the feed roller; and
4) wherein the feed roller is rotatable around the one or more feed magnets and the one or more take-off magnets.

10. The development station of claim 9, wherein the one or more feed magnets comprise a plurality of feed magnets and each of the plurality of feed magnets are arranged in alternating magnetic polarity.

11. The development station of claim 9, wherein the one or more take-off magnets comprise a plurality of take-off magnets and each of the plurality of take-off magnets are arranged in alternating polarity.

12. The development station of claim 9, wherein the one or more feed magnets and the one or more take-off magnets define a post-take-off gap.

13. The development station of claim 12, wherein:
a first feed magnet of the one or more feed magnets is adjacent the post-take-off gap;
a first take-off magnet of the one or more take-off magnets is adjacent the post-take-off gap; and
the first feed magnet and the first take-off magnet have the same polarity.

14. The development station of claim 9, wherein:
a first feed magnet of the one or more feed magnets is adjacent the post-feed gap;
a first take-off magnet of the one or more take-off magnets is adjacent the post-feed gap; and
the first feed magnet and the first take-off magnet have the same polarity.

15. The development station of claim 9, wherein the one or more feed magnets and the one or more take-off magnets define a post-feed gap; and
the feeding apparatus further comprises a magnetic shunt in the post-feed gap.

16. The development station of claim 9, wherein the feed roller further comprises a plurality of grooves.

17. The development station of claim 9, further comprising a metering skive configured to regulate a height of fresh developer on the rotating shell.

18. The development station of claim 9, further comprising a take-off skive configured to assist the one or more take-off magnets in removing depleted developer from the rotating shell.

19. The development station of claim 9, wherein the rotating shell and the feed roller define a minimum gap between the rotating shell and the feed roller;
a first take-off magnet of the one or more take-off magnets is nearer to the rotating shell than a remainder of the one or more take off magnets; and
an axis of the first take-off magnet is not aligned with the minimum gap between the rotating shell and the feed roller.

20. An electrophotographic imaging system, comprising:
a dielectric support member (DSM);
a primary charging station configured to form a charge layer on the DSM;
an exposure station configured to selectively discharge the charge layer formed on the DSM, thereby producing a latent image on the DSM; and
a development station configured to develop the latent image on the DSM with toner, wherein the development station comprises:
a) a rotating shell;
b) a rotating magnetic core within the rotating shell;
c) a sump region; and
d) a feeding apparatus configured to supply fresh developer from the sump region to the rotating shell, wherein the feeding apparatus comprises:
1) a feed roller;
2) one or more feed magnets within the feed roller;
3) one or more take-off magnets within the feed roller; and
4) wherein the feed roller is rotatable around the one or more feed magnets and the one or more take-off magnets.
